(19) United States
(12) Patent Application Publication
(10) Pub. No.: US 2011/0236646 A1
(43) Pub. Date: Sep. 29, 2011

(54) Ink composition, metal thin film prepared using the same and method of preparing the same

(75) Inventors: Young Kwan Seo, Suwon (KR); Kwi Jong Lee, Suwon (KR); Dong Hoon Kim, Seongnam (KR)

(73) Assignee: SAMSUNG ELECTRO-MECHANICS CO., LTD., Suwon (KR)

(21) Appl. No.: 12/926,141

(22) Filed: Oct. 27, 2010

(30) Foreign Application Priority Data
Mar. 26, 2010 (KR) 10-2010-0027389

(51) Int. Cl. C09D 11/02; C07F 1/12; B32B 3/10; B05D 5/12

(52) U.S. Cl. 428/195.1; 106/31.13; 556/110; 427/126.1

(57) ABSTRACT

There are provided an ink composition, a metal thin film prepared using the same, and a method of preparing the same. The ink composition according to the present invention includes: gold-containing complex compound represented by the following Formula 1 (L and L′ are at least one selected from a group consisting of diolefin and derivatives thereof, and X is at least one selected from a group consisting of chlorine (Cl), bromine (Br), and iodine (I), where m=an integer of 1˜10, n=an integer of 1˜10, o=an integer of 0˜10, and p=an integer of 0˜10); and a solvent dispersing the gold-containing complex compound.

AuₘLₙL′ₒXₚ Formula 1

The present invention can provide ink composition that can be sintered at low temperature by being optionally printed, a metal thin film prepared using the same, and a method of preparing the same.

### CROSS-REFERENCE TO RELATED APPLICATIONS

This application claims the priority of Korean Patent Application No. 10-2010-0027389 filed on Mar. 26, 2010, in the Korean Intellectual Property Office, the disclosure of which is incorporated herein by reference.

### BACKGROUND OF THE INVENTION

1. Field of the Invention

The present invention relates to an ink composition, a metal thin film prepared using the same, and a method of preparing the same, and more particularly, to an ink composition that can be sintered at low temperature by being optionally printed, a metal thin film prepared using the same, and a method of preparing the same.

2. Description of the Related Art

Generally, gold materials are usefully used to manufacture electronic devices, in particular, electronic package devices, such as integrated circuits, lead frames, and printed circuit boards and are introduced through an electrolysis plating or electroless substitute plating.

However, the plating process is an expensive process that is performed during a final process of a package substrate. Further, it is very difficult to manage pollution within a plating bath and the concentration of metal ions, or the like, in the plating process. In particular, the pollution of the plating bath causes defects in gold plating, such that loss due to the process defect, such as the discarding of defective package substrates, or the like, is very large.

In addition, an expensive gold plating liquid is substantially plated only on the mounting part as well as being plated on an unnecessary portion, such that the amount of gold loss is increased. As a result, demand for a method for optionally plating gold has been increased.

Further, the existing metal thin film may be formed by depositing metal organic materials using a chemical vapor deposition (CVD) method, an atomic layer deposition (ALD) method, a plasma deposition method, a sputtering method, an electrolysis plating method, an electroless plating method, or the like. However, there is a problem in that these methods can be used to manufacture a metal pattern by using many processes, such as a high vacuum process, a high temperature process, exposure, etching, or the like.

In order to simplify the many above-mentioned processes, much research into metal patterning using a drop on demand technology, such as an inkjet scheme, has recently been conducted. In particular, a method of dispersing, inking, and printing nano metal particles on a substrate has been researched. However, the method contains a large amount of dispersant in order to disperse the nano metal particles. Therefore, a high-temperature sintering process should be performed in order to remove the dispersant, such that the kind of substrate is limited.

### SUMMARY OF THE INVENTION

An aspect of the present invention provides an ink composition that can be sintered at low temperature by being optionally printed, a metal thin film prepared using the same, and a method of preparing the same.

According to an aspect of the present invention, there is provided an ink composition, including: a gold-containing complex compound represented by the following Formula 1 (L and L′ are at least one selected from a group consisting of diolefin and derivatives thereof, and X is at least one selected from a group consisting of chlorine (Cl), bromine (Br), and iodine (I), where m=an integer of 1˜10, n=an integer of 1˜10, o=an integer of 0˜10, and p=an integer of 0˜10); and a solvent dispersing the gold-containing complex compound.

AuₘLₙL′ₒXₚ Formula 1

The L and L′ may be at least any one selected from a group consisting of norbornadiene and derivatives thereof, dicyclopentadiene and derivatives thereof, and cyclooctatetraene and derivatives thereof.

For 100 wt % of ink composition, the gold-containing complex compound may be added at 0.1 wt % or more to 10 wt % or less.

The ink composition may further include a viscosity modifier modifying the viscosity of the ink composition.

The solvent may be at least one selected from a group consisting of diethylether, dichloromethane, ethyleneglycolmonomethylether, ethyleneglycolmonoarylether, diethyleneglycolbutylether, diethyleneglycolmethylether, diethyleneglycolethylether, dipropyleneglycoldimethylether, diethyleneglycoldiethylether, and diethyleneglycoldibutylether.

According to another aspect of the present invention, there is provided a metal thin film, including: a gold-containing complex compound represented by the following Formula 1 (L and L′ are at least one selected from a group consisting of diolefin and derivatives thereof, and X is at least one selected from a group consisting of chlorine (Cl), bromine (Br), and iodine (I), where m=an integer of 1˜10, n=an integer of 1˜10, o=an integer of 0˜10, and p=an integer of 0˜10).

AuₘLₙL′ₒXₚ Formula 1

The L and L′ may be at least any one selected from a group consisting of norbornadiene and derivatives thereof, dicyclopentadiene and derivatives thereof, and cyclooctatetraene and derivatives thereof.

The metal thin film may be formed by at least one selected from an inkjet printing method, a screen printing method, a gravure printing method, or an offset printing method, a spin coating method, a dip coating method, a flow coating method, a roll coating method, and a spray coating method.

According to another aspect of the present invention, there is provided a method of preparing an ink composition, including: preparing a reactive solution by dispersing a gold-containing complex compound represented by the following Formula 1 (L and L′ are at least one selected from a group consisting of diolefin and derivatives thereof, and X is at least one selected from a group consisting of chlorine (Cl), bromine (Br), and iodine (I), where m=an integer of 1˜10, n=an integer of 1˜10, o=an integer of 0˜10, and p=an integer of 0˜10) in a solvent; agitating the reactive solution to form a reactant; and washing and filtering the reactant to obtain products.

AuₘLₙL′ₒXₚ Formula 1

The L and L′ may be at least any one selected from a group consisting of norbornadiene and derivatives thereof, dicyclopentadiene and derivatives thereof, and cyclooctatetraene and derivatives thereof.

For 100 wt % of ink composition, the gold-containing complex compound may be added at 0.1 wt % or more to 10 wt % or less.

The preparing of the reactive solution may include adding a viscosity modifier modifying the viscosity of the ink composition.

The solvent may be at least one selected from a group consisting of diethylether, dichloromethane, ethyleneglycolmonomethylether, ethyleneglycolmonoarylether, diethyleneglycolbutylether, diethyleneglycolmethylether, diethyleneglycolethylether, dipropyleneglycoldimethylether, diethyleneglycoldiethylether, and diethyleneglycoldibutylether.

According to another aspect of the present invention, there is provided a method of preparing a metal thin film, including: applying ink composition including a gold-containing complex compound represented by the following Formula 1 (L and L′ are at least one selected from a group consisting of diolefin and derivatives thereof, and X is at least one selected from a group consisting of chlorine (Cl), bromine (Br), and iodine (I), where m=an integer of 1˜10, n=an integer of 1˜10, o=an integer of 0˜10, and p=an integer of 0˜10) and a solvent to a substrate; and heat-treating the ink composition.

AuₘLₙL′ₒXₚ Formula 1

During the applying of the ink composition to the substrate, the substrate may be formed of at least any one selected from the organic matter containing substrate and the inorganic matter containing substrate.

During the applying of the ink composition to the substrate, the substrate may be made of at least any one selected from bismaleimide triazine, polyester, polyimide, glass, and silicon.

The ink composition may be heat-treated under at least any one selected from an air atmosphere, a nitrogen atmosphere, a hydrogen atmosphere, an argon atmosphere, an oxygen atmosphere, and an atmosphere which is a mixture thereof.

During the heat-treating of the ink composition, the ink composition may be heat-treated at a temperature exceeding 0° C. and less than 200° C.

L and L′ may be at least any one selected from a group consisting of norbornadiene and derivatives thereof, dicyclopentadiene and derivatives thereof, and cyclooctatetraene and derivatives thereof.

For 100 wt % of ink composition, the gold-containing complex compound may be added at 0.1 wt % or more to 10 wt % or less.

During the preparing the reactive solution, a viscosity modifier modifying the viscosity of the ink composition may further be added.

The solvent may be at least one selected from a group consisting of diethylether, dichloromethane, ethyleneglycolmonomethylether, ethyleneglycolmonoarylether, diethyleneglycolbutylether, diethyleneglycolmethylether, diethyleneglycolethylether, dipropyleneglycoldimethylether, diethyleneglycoldiethylether, and diethyleneglycoldibutylether.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a printing image of a metal thin film according to a first exemplary embodiment of the present invention.

### DETAILED DESCRIPTION OF THE PREFERRED EMBODIMENT

Exemplary embodiments of the present invention will now be described in detail with reference to the accompanying drawings. The exemplary embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

Hereinafter, the present invention will be described in greater detail.

The ink composition according to an exemplary embodiment of the present invention includes a gold-containing complex compound represented by Formula 1 and a solvent dispersing the gold-containing complex compound.

AuₘLₙL′ₒXₚ Formula 1

In Formula 1, L and L′ may be at least one selected from a group consisting of diolefin and derivatives thereof, preferably, at least any one selected from a group consisting of norbornadiene and derivatives thereof, dicyclopentadiene and derivatives thereof, and cyclooctatetraene and derivatives thereof. X is at least one selected from a group consisting of chlorine (Cl), bromine (Br), and iodine (I), where m=an integer of 1˜10, n=an integer of 1˜10, o=an integer of 0˜10, and p=an integer of 0˜10.

For 100 wt % of ink composition, the gold-containing complex compound may be added at 0.1 wt % to 10 wt %. Within the ink composition, when the amount of gold-containing complex compound is less than 1 wt %, it is impossible to evenly form a coating film and when the amount of gold-containing complex compound exceeds 10 wt %, sediment may occur due to the reduction of solubility thereby caused.

Further, a viscosity modifier modifying the viscosity of the ink composition may be added during a process of preparing the reactive solution. In this case, if the viscosity modifier can modify the viscosity of the ink composition, any viscosity modifiers can be used, including market-available viscosity modifiers.

Meanwhile, for 100 wt % of ink composition, a solvent may be added as the residual amount, except for the gold-containing complex compound. In addition, when the viscosity modifier is added to the ink composition, the solvent may be added as the residual amount, except for the gold-containing complex compound and the viscosity modifier.

The type of the solvent dispersing the gold-containing complex compound is not specifically limited. The solvent may be at least one selected from a group consisting of diethylether, dichloromethane, ethyleneglycolmonomethylether, ethyleneglycolmonoarylether, diethyleneglycolbutylether, diethyleneglycolmethylether, diethyleneglycolethylether, dipropyleneglycoldimethylether, diethyleneglycoldiethylether, and diethyleneglycoldibutylether.

The metal thin film according to the exemplary embodiment of the present invention includes the gold-containing complex compound represented by the following Formula 1.

AuₘLₙL′ₒXₚ Formula 1

In Formula 1, L and L′ may be at least one selected from a group consisting of diolefin and derivatives thereof, preferably, at least any one selected from a group consisting of norbornadiene and derivatives thereof, dicyclopentadiene and derivatives thereof, and cyclooctatetraene and derivatives thereof. X is at least one selected from a group consisting of chlorine (Cl), bromine (Br), and iodine (I), where m=an integer of 1˜10, n=an integer of 1˜10, o=an integer of 0˜10, and p=an integer of 0˜10.

The metal thin film may be formed by at least one selected from an inkjet printing method, a screen printing method, a gravure printing method, or an offset printing method, a spin coating method, a dip coating method, a flow coating method, a roll coating method, and a spray coating method, but the method of forming the metal thin film is not limited thereto. As a result, all the methods capable of optionally forming a metal thin film can be used. In other words, the method of preparing the metal thin film according to the exemplary embodiment of the present invention can improve the disadvantage of preparing the metal thin film by using many processes, such as high vacuum, high temperature, exposure, etching, or the like, due to the use of the chemical vapor deposition (CVD) method, the atomic layer deposition (ALD) method, the plasma deposition method, the sputtering method, the electrolysis plating method, the electroless plating method, or the like.

The method of preparing the ink composition according to the exemplary embodiment of the present invention includes preparing the reactive solution by dispersing the gold-containing complex compound represented by the following Formula 1 in a first solvent, agitating the reactive solution to form reactants, and washing and filtering the reactants to obtain products.

AuₘLₙL′ₒXₚ Formula 1

In Formula 1, L and L′ may be at least one selected from a group consisting of diolefin and derivatives thereof, preferably, at least any one selected from a group consisting of norbornadiene and derivatives thereof, dicyclopentadiene and derivatives thereof, and cyclooctatetraene and derivatives thereof. X is at least one selected from a group consisting of chlorine (Cl), bromine (Br), and iodine (I), where m=an integer of 1˜10, n=integer of 1˜10, o=integer of 0˜10, and p=integer of 0˜10.

For 100 wt % of ink composition, the gold-containing complex compound may be added at 0.1 wt % to 10 wt %. Among the ink composition, when the amount of gold-containing complex compound is less than 1 wt %, it is impossible to evenly form a coating film and when the amount of gold-containing complex compound exceeds 10 wt %, sediment may occur due to the reduction of solubility thereby caused.

Further, a viscosity modifier modifying the viscosity of the ink composition may be added during a process of preparing the reactive solution. In this case, if the viscosity modifier can modify the viscosity of the ink composition, any viscosity modifiers can be used, including market-available viscosity modifiers.

Meanwhile, for 100 wt % of ink composition, a solvent may be added as the residual amount, except for the gold-containing complex compound. In addition, when the viscosity modifier is added to the ink composition, the solvent may be added as the residual amount, except for the gold-containing complex compound and the viscosity modifier.

The type of the solvent dispersing the gold-containing complex compound is not specifically limited. The solvent may be at least one selected from a group consisting of diethylether, dichloromethane, ethyleneglycolmonomethylether, ethyleneglycolmonoarylether, diethyleneglycolbutylether, diethyleneglycolmethylether, diethyleneglycolethylether, dipropyleneglycoldimethylether, diethyleneglycoldiethylether, and diethyleneglycoldibutylether.

The method of preparing the metal thin film according to the exemplary embodiment of the present invention includes applying the ink composition including the metal containing complex compound represented by the following Formula 1 and the solvent to the substrate and heat-treating the ink composition.

AuₘLₙL′ₒXₚ Formula 1

In Formula 1, L and L′ may be at least one selected from a group consisting of diolefin and derivatives thereof, preferably, at least any one selected from a group consisting of norbornadiene and derivatives thereof, dicyclopentadiene and derivatives thereof, and cyclooctatetraene and derivatives thereof. X is at least one selected from a group consisting of chlorine (Cl), bromine (Br), and iodine (I), where m=an integer of 1˜10, n=an integer of 1˜10, o=an integer of 0˜10, and p=an integer of 0˜10.

For 100 wt % of ink composition, the gold-containing complex compound may be added at 0.1 wt % to 10 wt %. Among the ink composition, when the amount of gold-containing complex compound is less than 1 wt %, it is impossible to evenly form a coating film and when the amount of gold-containing complex compound exceeds 10 wt %, sediment may occur due to the reduction of solubility.

Further, a viscosity modifier modifying the viscosity of the ink composition may be added during a process of preparing the reactive solution. In this case, if the viscosity modifier can modify the viscosity of the ink composition, any viscosity modifiers can be used, including market-available viscosity modifiers.

Meanwhile, for 100 wt % of ink composition, a solvent may be added as the residual amount, except for the gold-containing complex compound. In addition, when the viscosity modifier is added to the ink composition, the solvent may be added as the residual amount, except for the gold-containing complex compound and the viscosity modifier.

A kind of the solvent dispersing the gold-containing complex compound is not specifically limited. The solvent may be at least one selected from a group consisting of diethylether, dichloromethane, ethyleneglycolmonomethylether, ethyleneglycolmonoarylether, diethyleneglycolbutylether, diethyleneglycolmethylether, diethyleneglycolethylether, dipropyleneglycoldimethylether, diethyleneglycoldiethylether, and diethyleneglycoldibutylether.

During the applying of the ink composition to the substrate, the substrate may be formed of at least any one selected from the organic matter containing substrate and the inorganic matter containing substrate. The reason is that the ink composition can be heat-treated at a temperature of 200° C. or less. The substrate may be made of at least any one selected from bismaleimide triazine, polyester, polyimide, glass, and silicon.

The existing ink composition contains a large amount of dispersant in order to disperse metal particles, such that the sintering should be performed at a high temperature of 250° C. or more after the ink composition is applied to the substrate in order to remove a large amount of dispersant. As a result, there is a problem in that the type of substrate is limited. However, the kind of substrate to which the ink composition containing the metal thin film according to the exemplary embodiment of the present invention is applied is not limited, in comparison to the existing substrate to which the ink composition containing the metal particles being limited is applied.

Further, the ink composition is heat-treated under at least any one selected from an air atmosphere, a nitrogen atmosphere, a hydrogen atmosphere, an argon atmosphere, an oxygen atmosphere, and atmosphere that is a mixture thereof.

Hereinafter, preferred examples and comparative examples of the present invention will be described. However, the following examples are only the preferred examples of the present invention and therefore, the present invention is not limited thereto the following examples.

### Example 1

1.8 g of HAuCl₄3H₂O (4.57 mmol) was melted in 30 mL of diethyl ether and 2.3 g (24.96 mmol) of norbornadiene was slowly injected into a 100 mL schlenk flask and then, agitated and reacted for 1 hour. A white solid was generated according to the progress of the reaction. Thereafter, a liquid was filtered with a membrane filter and was washed with 20 mL of cold diethyl ether three times and a solvent was removed with vacuum filtration, thereby obtaining 0.8 g of white gold-containing complex compound (yield: 53.8%).

### Example 2

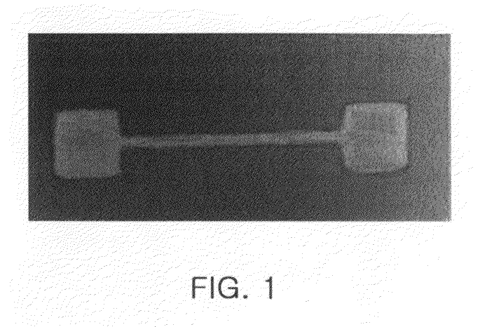

0.8 g of the gold-containing complex compound prepared in Example 1 was melted into 6.7 g of 2 (2-butoxyethoxy) ethanol, thereby preparing the ink composition having 5.3 cp of viscosity and 30.8 mN/m of surface tension. The printing image of the metal thin film formed by printing the prepared ink composition on the substrate made of bismaleimide triazine by the inkjet printing method and then, heat treatment was performed for 10 minutes at 150° C. as shown in FIG. 1.

### Comparative Example

1.8 g of HAuCl₄3H₂O (4.57 mmol) was melted in 30 mL of diethyl ether and 2.7 g (25 mmol) of 1,5-cyclooctadiene was slowly injected into a 100 mL schlenk flask and then, agitated and reacted for 1 hour. A white solid was generated according to the progress of the reaction. Thereafter, a liquid was filtered with the membrane filter and was washed with 20 mL of cold diethyl ether three times and a solvent was removed under vacuum, thereby obtaining 0.9 g of white powders (yield: 48%). Dissolving the white powders in solvents such as 2 (2-butoxyethoxy) ethanol, toluene, tetrahydrofuran, ethanol, or the like was attempted, but were not dissolved.

As set forth above, the present invention can provide an ink composition that can be sintered at low temperature by being optionally printed, a metal thin film prepared using the same, and a method of preparing the same.

The method of preparing the metal thin film containing the ink composition including the gold-containing complex compound prepared in Example 1 can improve the disadvantages of preparing the metal thin film by using many processes such as the existing high vacuum, the high temperature, the exposure, the etching, or the like.

Further, the metal thin film prepared with the ink composition of Example 1 prepared in Example 2 can be heat-treated at a temperature of 200° C. or less, such that various kinds of substrates can be used without being limited, different from the existing substrate applied with the ink composition containing the metal particles being limited.

As set forth above, the present invention can provide the ink composition that can be sintered at low temperature by being optionally printed, the metal thin film prepared using the same, and the method of preparing the same.

In addition, the method of preparing the metal thin film containing the ink composition including gold-containing complex compound according to the present invention does not include performing many processes such as high vacuum, high temperature, exposure, etching, or the like, due to the chemical vapor deposition (CVD) method, the atomic layer deposition (ALD) method, the plasma deposition method, and the sputtering method in the related art, thereby making it possible to save on process costs. The process also does not include the expensive gold plating liquid due to the electrolysis plating method and the electroless plating method, thereby making it possible to save on manufacturing costs.

In addition, the metal thin film according to the present invention can be heat-treated at low temperature, such that various kinds of substrates can be used without being limited, in comparison to the existing substrate applied with the ink composition containing the metal particles which is limited.

While the present invention has been shown and described in connection with the exemplary embodiments, it will be apparent to those skilled in the art that modifications and variations can be made without departing from the spirit and scope of the invention as defined by the appended claims.

What is claimed is:

1. An ink composition, comprising:
gold-containing complex compound represented by the following Formula 1 (L and L′ are at least one selected from a group consisting of diolefin and derivatives thereof, and X is at least one selected from a group consisting of chlorine (Cl), bromine (Br), and iodine (I), where m=an integer of 1˜10, n=an integer of 1˜10, o=an integer of 0˜10, and p=an integer of 0˜10); and
a solvent dispersing the gold-containing complex compound.
AuₘLₙL′ₒXₚ Formula 1

2. The ink composition of claim 1, wherein the L and L′ are at least any one selected from a group consisting of norbornadiene and derivatives thereof, dicyclopentadiene and derivatives thereof, and cyclooctatetraene and derivatives thereof.

3. The ink composition of claim 1, wherein for 100 wt % of ink composition, the gold-containing complex compound is added at 0.1 wt % or more to 10 wt % or less.

4. The ink composition of claim 1, further comprising a viscosity modifier modifying the viscosity of the ink composition.

5. The ink composition of claim 1, wherein the solvent is at least one selected from a group consisting of diethylether, dichloromethane, ethyleneglycolmonomethylether, ethyleneglycolmonoarylether, diethyleneglycolbutylether, diethyleneglycolmethylether, diethyleneglycolethylether, dipropyleneglycoldimethylether, diethyleneglycoldiethylether, and diethyleneglycoldibutylether.

6. A metal thin film, comprising:
gold-containing complex compound represented by the following Formula 1 (L and L′ are at least one selected from a group consisting of diolefin and derivatives thereof, and X is at least one selected from a group consisting of chlorine (Cl), bromine (Br), and iodine (I), where m=an integer of 1˜10, n=an integer of 1˜10, o=an integer of 0˜10, and p=an integer of 0˜10).
AuₘLₙL′ₒXₚ Formula 1

7. The metal thin film of claim 6, wherein the L and L′ are at least any one selected from a group consisting of norbornadiene and derivatives thereof, dicyclopentadiene and derivatives thereof, and cyclooctatetraene and derivatives thereof.

8. The metal thin film of claim 6, wherein the metal thin film is formed by at least one selected from an inkjet printing method, a screen printing method, a gravure printing method, or an offset printing method, a spin coating method, a dip coating method, a flow coating method, a roll coating method, and a spray coating method.

9. A method of preparing an ink composition, comprising:
preparing a reactive solution by dispersing gold-containing complex compound represented by the following Formula 1 (L and L′ are at least one selected from a group consisting of diolefin and derivatives thereof, and X is at least one selected from a group consisting of chlorine (Cl), bromine (Br), and iodine (I), where m=an integer of 1˜10, n=an integer of 1˜10, o=an integer of 0˜10, and p=an integer of 0˜10) in a solvent;
agitating the reactive solution to form a reactant; and
washing and filtering the reactant to obtain products.
AuₘLₙL′ₒXₚ Formula 1

10. The method of preparing an ink composition of claim 9, wherein the L and L′ are at least any one selected from a group consisting of norbornadiene and derivatives thereof, dicyclopentadiene and derivatives thereof, and cyclooctatetraene and derivatives thereof.

11. The method of preparing an ink composition of claim 9, wherein for 100 wt % of ink composition, the gold-containing complex compound is added at 0.1 wt % or more to 10 wt % or less.

12. The method of preparing an ink composition of claim 9, wherein the preparing of the reactive solution includes adding a viscosity modifier modifying the viscosity of the ink composition.

13. The method of preparing an ink composition of claim 9, wherein the solvent is at least one selected from a group consisting of diethylether, dichloromethane, ethyleneglycolmonomethylether, ethyleneglycolmonoarylether, diethyleneglycolbutylether, diethyleneglycolmethylether, diethyleneglycolethylether, dipropyleneglycoldimethylether, diethyleneglycoldiethylether, and diethyleneglycoldibutylether.

14. A method of preparing a metal thin film, comprising:
applying ink composition including gold-containing complex compound represented by the following Formula 1 (L and L′ are at least one selected from a group consisting of diolefin and derivatives thereof, and X is at least one selected from a group consisting of chlorine (Cl), bromine (Br), and iodine (I), where m=an integer of 1˜10, n=an integer of 1˜10, o=an integer of 0˜10, and p=an integer of 0˜10) and a solvent to a substrate; and
heat-treating the ink composition.
AuₘLₙL′ₒXₚ Formula 1

15. The method of preparing a metal thin film of claim 14, wherein during the applying of the ink composition to the substrate, the substrate is formed of at least anyone selected from the organic matter containing substrate and the inorganic matter containing substrate.

16. The method of preparing a metal thin film of claim 14, wherein during the applying of the ink composition to the substrate, the substrate is made of at least any one selected from bismaleimide triazine, polyester, polyimide, glass, and silicon.

17. The method of preparing a metal thin film of claim 14, wherein the ink composition is heat-treated under at least anyone selected from an air atmosphere, a nitrogen atmosphere, a hydrogen atmosphere, an argon atmosphere, an oxygen atmosphere, and an atmosphere which is a mixture thereof.

18. The method of preparing a metal thin film of claim 14, wherein during the heat-treating of the ink composition, the ink composition is heat-treated at a temperature exceeding 0° C. and being less than 200° C.

19. The method of preparing a metal thin film of claim 14, wherein L and L′ are at least any one selected from a group consisting of norbornadiene and derivatives thereof, dicyclopentadiene and derivatives thereof, and cyclooctatetraene and derivatives thereof.

20. The method of preparing a metal thin film of claim 14, wherein for 100 wt % of ink composition, the gold-containing complex compound is added at 0.1 wt % or more to 10 wt % or less.

21. The method of preparing a metal thin film of claim 14, further comprising a viscosity modifier modifying the viscosity of the ink composition.

22. The method of preparing a metal thin film of claim 14, wherein the solvent is at least one selected from a group consisting of diethylether, dichloromethane, ethyleneglycolmonomethylether, ethyleneglycolmonoarylether, diethyleneglycolbutylether, diethyleneglycolmethylether, diethyleneglycolethylether, dipropyleneglycoldimethylether, diethyleneglycoldiethylether, and diethyleneglycoldibutylether.
